(19) United States
(12) Patent Application Publication
(10) Pub. No.: US 2021/0242813 A1
(43) Pub. Date: Aug. 5, 2021

(54) Robot

(71) Applicant: Seiko Epson Corporation, Toyko (JP)

(72) Inventor: Makoto KUDO, Fujimi (JP)

(21) Appl. No.: 17/162,134

(22) Filed: Jan. 29, 2021

(30) Foreign Application Priority Data
Jan. 31, 2020 (JP) 2020-014613

(51) Int. Cl. H02P 21/22; B25J 19/06; H02K 29/08; H02M 7/515

(52) U.S. Cl. CPC H02P 21/22; H02M 7/515; H02K 29/08; B25J 19/06

(57) ABSTRACT

A robot includes a motor driven by a three-phase alternating current, an AC conversion section configured to convert a direct current into a three-phase alternating current and output the three-phase alternating current to the motor, a first detecting section configured to detect a current value of the direct current before being input to the AC conversion section, a second detecting section configured to detect a current value of the direct current before being input to the AC conversion section or the three-phase alternating current output by the AC conversion section, a power-supply adjusting section configured to adjust power supply to the motor, and a control section configured to control operation of the power-supply adjusting section based on at least one of a detection result of the first detecting section and a detection result of the second detecting section.

The present application is based on, and claims priority from JP Application Serial Number 2020-014613, filed Jan. 31, 2020, the disclosure of which is hereby incorporated by reference herein in its entirety.

### BACKGROUND

### 1. Technical Field

The present disclosure relates to a robot.

### 2. Related Art

For example, as described in JP-A-2019-034393 (Patent Literature 1), a robot driven by a motor has been known. The robot described in Patent Literature 1 can detect, by detecting a current value of the motor, that an external object comes into contact with a robot main body. Consequently, when detecting that the external object comes into contact with the robot main body, the robot can secure safety by, for example, stopping the driving of the robot main body.

In a robot, in general, a servomotor driven by a three-phase alternating current is used. To detect a current value of the servomotor, it is necessary to detect at least two among a first phase, a second phase, and a third phase. That is, in a detecting section that detects the current value of the servomotor, at least two detection elements are necessary. On the other hand, from the viewpoint of improving safety, multiplexing, in particular, duplexing of element components of the robot has been known.

However, when the detecting section is duplexed, at least four detection elements are necessary and a device configuration is complicated.

### SUMMARY

A robot according to an application example includes: a motor driven by a three-phase alternating current; an AC conversion section configured to convert a direct current into a three-phase alternating current and output the three-phase alternating current to the motor; a first detecting section configured to detect a current value of the direct current before being input to the AC conversion section; a second detecting section configured to detect a current value of the direct current before being input to the AC conversion section or the three-phase alternating current output by the AC conversion section; a power-supply adjusting section configured to adjust power supply to the motor; and a control section configured to control operation of the power-supply adjusting section based on at least one of a detection result of the first detecting section and a detection result of the second detecting section.

A robot according to an application example includes: a motor driven by a three-phase alternating current; an AC conversion section configured to convert a direct current into a three-phase alternating current and output the three-phase alternating current to the motor; a first detecting section configured to detect a current value of the direct current before being input to the AC conversion section; a power-supply adjusting section configured to adjust power supply to the motor; and a control section configured to control operation of the power-supply adjusting section based on at least one of a detection result of the first detecting section and a current command value to the motor.

### BRIEF DESCRIPTION OF THE DRAWINGS

FIG. 1 is a schematic configuration diagram of a robot system including a robot according to the present disclosure.

FIG. 2 is a block diagram of the robot system shown in FIG. 1.

FIG. 3 is a circuit diagram of the robot system shown in FIG. 1.

FIG. 4 is a circuit diagram of a modification of the robot system.

FIG. 5 is a circuit diagram of a second embodiment of the robot according to the present disclosure.

FIG. 6 is a detailed circuit diagram of the robot shown in FIG. 5.

### DESCRIPTION OF EXEMPLARY EMBODIMENTS

A robot according to the present disclosure is explained in detail below based on preferred embodiments shown in the accompanying drawings.

### First Embodiment

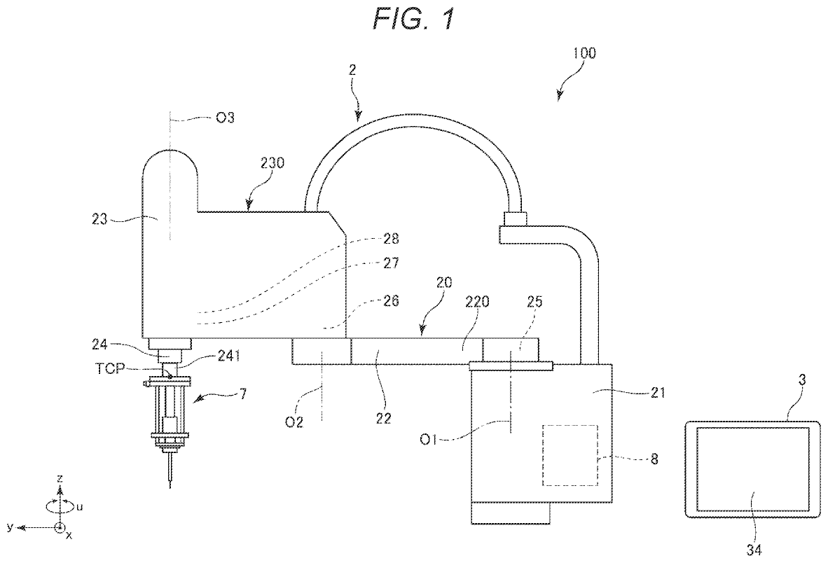

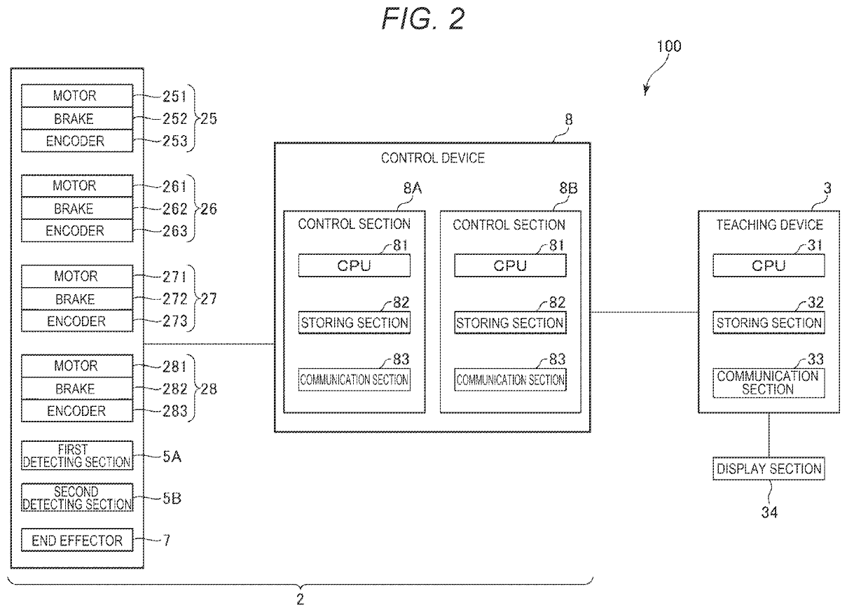

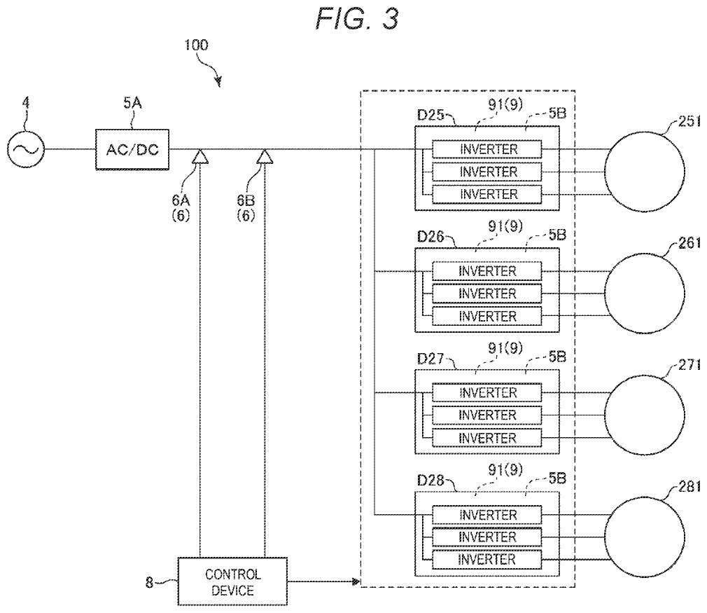

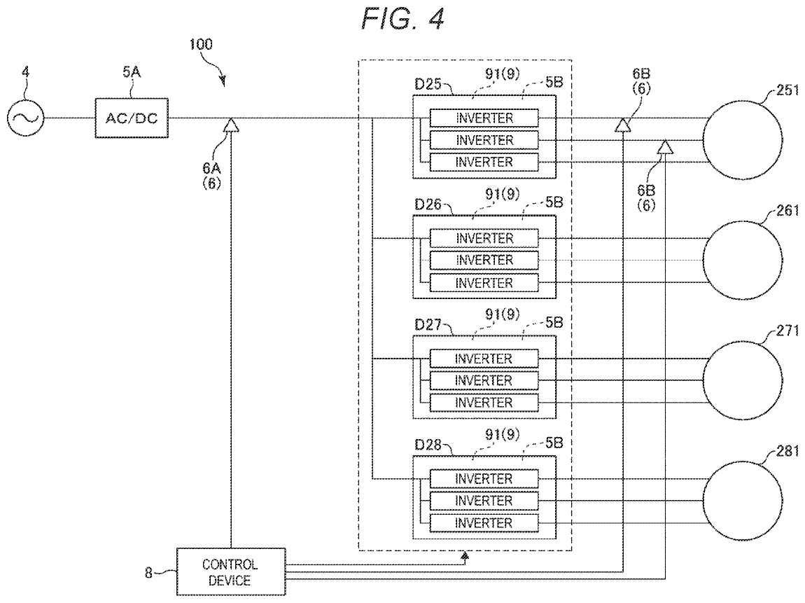

FIG. 1 is a schematic configuration diagram of a robot system including a robot according to the present disclosure. FIG. 2 is a block diagram of the robot system shown in FIG. 1. FIG. 3 is a circuit diagram of the robot system shown in FIG. 1. FIG. 4 is a circuit diagram of a modification of the robot system.

In FIG. 1, for convenience of explanation, an x axis, a y axis, and a z axis are shown as three axes orthogonal to one another. In the following explanation, a direction parallel to the x axis is referred to as “x-axis direction” as well, a direction parallel to the y axis is referred to as “y-axis direction” as well, and a direction parallel to the z axis is referred to as “z-axis direction” as well.

In the following explanation, for convenience of explanation, in FIG. 1, a +z-axis direction, that is, the upper side is referred to as “upper” or “upward” as well and a −z-axis direction, that is, the lower side is referred to as “lower” or “downward” as well. Concerning a robot arm 20, in FIG. 1, a base 21 side is referred to as “proximal end” and the opposite side of the base 21 side, that is, an end effector 7 side is referred to as “distal end”. In FIG. 1, the z-axis direction, that is, the up-down direction is represented as “vertical direction” and the x-axis direction and the y-axis direction, that is, the left-right direction is represented as “horizontal direction”.

A robot system 100 shown in FIGS. 1 and 2 is, for example, an apparatus used in work such as holding, conveyance, assembly, and inspection of work such as electronic components and electronic devices. The robot system 100 includes a robot 2 and a teaching device 3 that teaches an operation program to the robot 2. The robot 2 and the teaching device 3 are communicably connected by wire or by radio. The communication between the robot 2 and the teaching device 3 may be performed via a network such as the Internet.

First, the robot 2 is explained.

In an illustrated configuration, the robot 2 is a horizontal articulated robot, that is, a SCARA robot. As shown in FIGS. 1 to 3, the robot 2 includes a base 21, a robot arm 20 coupled to the base 21, an end effector 7, and a control device 8 that controls the operations of these sections.

The base 21 is a portion that supports the robot arm 20. The control device 8 explained below is incorporated in the base 21. The origin of a robot coordinate system is set in any portion of the base 21. The x axis, the y axis, and the z axis shown in FIG. 1 are axes of the robot coordinate system.

The robot arm 20 includes a first arm 22, a second arm 23, and a third arm 24, which is a work head. A coupling portion of the base 21 and the first arm 22, a coupling portion of the first arm 22 and the second arm 23, and a coupling portion of the second arm 23 and the third arm 24 are referred to as joints as well.

The robot 2 is not limited to the illustrated configuration. The number of arms may be one or two or may be four or more.

The robot 2 includes a driving unit 25 that rotates the first arm 22 with respect to the base 21, a driving unit 26 that rotates the second arm 23 with respect to the first arm 22, a u-driving unit 27 that rotates a shaft 241 of the third arm 24 with respect to the second arm 23, and a z-driving unit 28 that moves the shaft 241 in the z-axis direction with respect to the second arm 23.

As shown in FIGS. 1 and 2, the driving unit 25 is incorporated in a housing 220 of the first arm 22 and includes a motor 251 that generates a driving force, a brake 252, a not-shown speed reducer that reduces the driving force of the motor 251, and an encoder 253 that detects a rotation angle of a rotation axis of the motor 251 or the speed reducer.

The driving unit 26 is incorporated in a housing 230 of the second arm 23 and includes a motor 261 that generates a driving force, a brake 262, a not-shown speed reducer that reduces the driving force of the motor 261, and an encoder 263 that detects a rotation angle of a rotation axis of the motor 261 or the speed reducer.

The u-driving unit 27 is incorporated in the housing 230 of the second arm 23 and includes a motor 271 that generates a driving force, a brake 272, a not-shown speed reducer that reduces the driving force of the motor 271, and an encoder 273 that detects a rotation angle of a rotation axis of the motor 271 or the speed reducer.

The z-driving unit 28 is incorporated in the housing 230 of the second arm 23 and includes a motor 281 that generates a driving force, a brake 282, a not-shown speed reducer that reduces the driving force of the motor 281, and an encoder 283 that detects a rotation angle of a rotation axis of the motor 281 or the speed reducer.

As the motor 251, the motor 261, the motor 271, and the motor 281, servomotors such as an AC servomotor and a DC servomotor can be used. As the speed reducer, for example, a speed reducer of a planetary gear type and a wave motion gear device can be used.

The brake 252, the brake 262, the brake 272, and the brake 282 have a function of decelerating the robot arm 20. Specifically, the brake 252 reduces operating speed of the first arm 22, the brake 262 reduces operating speed of the second arm 23, the brake 272 reduces operating speed in the u direction of the third arm 24, and the brake 282 reduces operating speed in the z-axis direction of the third arm 24.

The control device 8 changes an energization condition to thereby operate to respectively decelerate parts of the robot arm 20. The brake 252, the brake 262, the brake 272, and the brake 282 are controlled by the control device 8 independently from the motor 251, the motor 261, the motor 271, and the motor 281. That is, ON and OFF of energization to the motor 251, the motor 261, the motor 271, and the motor 281 and ON and OFF of energization to the brake 252, the brake 262, the brake 272, and the brake 282 are not associated.

Examples of the brake 252, the brake 262, the brake 272, and the brake 282 include an electromagnetic brake, a mechanical brake, a hydraulic brake, and a pneumatic brake. In the following explanation, it is assumed that the brake 252, the brake 262, the brake 272, and the brake 282 are electromagnetic brakes. As the electromagnetic brake, there are an excitation operation type for decelerating the robot arm 20 when being energized and a non-excitation operation type for decelerating the robot arm 20 when being deenergized. In the following explanation, it is assumed that the electromagnetic brake is the excitation operation type that decelerates the robot arm 20 with energization.

As shown in FIG. 2, the encoder 253, the encoder 263, the encoder 273, and the encoder 283 are position detecting sections that detect the position of the robot arm 20. The encoder 253, the encoder 263, the encoder 273, and the encoder 283 are respectively electrically coupled to the control device 8. The encoder 253, the encoder 263, the encoder 273, and the encoder 283 transmit information concerning detected rotation angles to the control device 8 as electric signals. Consequently, the control device 8 can control the operation of the robot arm 20 based on the received information concerning the rotation angles.

As shown in FIG. 3, the driving unit 25 is coupled to a motor driver D25 and controlled by the control device 8 via the motor driver D25. The driving unit 26 is coupled to a motor driver D26 and controlled by the control device 8 via the motor driver D26. The u-driving unit 27 is coupled to a motor driver D27 and controlled by the control device 8 via the motor driver D27. The z-driving unit 28 is coupled to a motor driver D28 and controlled by the control device 8 via the motor driver D28.

For example, the base 21 is fixed to a not-shown floor surface by bolts or the like. The first arm 22 is coupled to the upper end portion of the base 21. The first arm 22 is capable of rotating around a first axis O1, which is along the vertical direction, with respect to the base 21. When the driving unit 25 that rotates the first arm 22 is driven, the first arm 22 rotates in a horizontal plane around the first axis O1 with respect to the base 21. A rotation amount of the first arm 22 with respect to the base 21 can be detected by the encoder 253.

The second arm 23 is coupled to the distal end portion of the first arm 22. The second arm 23 is capable of rotating around a second axis O2, which is along the vertical direction, with respect to the first arm 22. The axial direction of the first axis O1 and the axial direction of the second axis O2 are the same. That is, the second axis O2 is parallel to the first axis O1. When the driving unit 26 that rotates the second arm 23 is driven, the second arm 23 rotates in a horizontal plane around the second axis O2 with respect to the first arm 22. A driving amount, specifically, a rotation amount of the second arm 23 with respect to the first arm 22 can be detected by the encoder 263.

The third arm 24 is set and supported at the distal end portion of the second arm 23. The third arm 24 includes the shaft 241. The shaft 241 is capable of rotating around a third axis O3, which is along the vertical direction, with respect to the second arm 23 and is capable of moving in the up-down direction. The shaft 241 is an arm at the most distal end of the robot arm 20.

When the u-driving unit 27 that rotates the shaft 241 is driven, the shaft 241 rotates around the z axis. A rotation amount of the shaft 241 with respect to the second arm 23 can be detected by the encoder 273.

Whet the z-driving unit 28 that moves the shaft 241 in the z-axis direction is driven, the shaft 241 moves in the up-down direction, that is, the z-axis direction. A movement amount in the z-axis direction of the shaft 241 with respect to the second arm 23 can be detected by the encoder 283.

In the robot 2, the distal end of the shaft 241 is set as a control point TCP. A distal end coordinate system having the control point TCP as the origin is set. The distal end coordinate system is already calibrated with the robot coordinate system explained above. A position in the distal end coordinate system can be converted into a position in the robot coordinate system. Consequently, the position of the control point TCP can be specified by the robot coordinate system.

Various end effectors are detachably coupled to the lower end of the shaft 241. The end effectors are not particularly limited. Examples of the end effectors include an end effector for gripping a conveyed object, an end effector for machining a workpiece, and an end effector used for inspection. In this embodiment, the end effector 7 is detachably coupled.

In this embodiment, the end effector 7 is not a component of the robot 2. However, a part of or the entire end effector 7 may be a component of the robot 2.

The control device 8 is explained.

The control device 8 is so-called “duplexed” and includes a control section 8A and a control section 8B. That is, even when an abnormality occurs in one of the control section 8A and the control section 8B, normal driving of the robot 2 can be realized by using the other. The control device 8 is excellent in safety. The control section 8A and the control section 8B have the same function and have, for example, a function of controlling driving of the robot arm 20 based on a current value explained below.

In the control device 8, in this embodiment, only the control section 8A operates at normal time. The control section 8B operates when the control section 8A is broken down. However, the control device 8 is not limited this configuration. The control device 8 may have a configuration in which only the control section 8B operates at normal time and the control section 8A operates when the control section 8B is broken down or a configuration in which both of the control section 8A and the control section 8B always operate.

Since the control section 8A and the control section 8B have the same configuration, the control section 8A is representatively explained below.

As shown in FIG. 2, the control section 8A has a function of controlling driving of the sections of the robot explained above and is electrically coupled to the sections of the robot 2. The control device 8 includes a CPU (Central Processing Unit) 81, a storing section 82, and a communication section 83. These sections are communicably coupled to one another via, for example, a bus.

The CPU 81 reads out and executes various programs and the like stored in the storing section 82. A command signal generated by the CPU 81 is transmitted to the sections of the robot 2 via the communication section 83. Consequently, the robot arm 20 can execute predetermined work.

The storing section 82 saves various programs and the like executable by the CPU 81. Examples of the storing section 82 include a volatile memory such as a RAM (Random Access Memory), a nonvolatile memory such as a ROM (Read Only Memory), and a detachable external storage device.

In the storing section 82, as explained below, a threshold of a current value or the like is stored as a reference for determination of ON/OFF of switches 91.

The communication section 83 performs transmission and reception of signals respectively between the communication section 83 and the sections of the robot 2 and the teaching device 3 using an external interface such as a wired LAN (Local Area Network) or a wireless LAN.

Such a control device 8 is incorporated in the base 21. However, the control device 8 is not limited to this configuration and may be set in any position on the outside of the base 21. In this case, the coupling of the control device 8 and the sections of the robot 2 may be wired or may be wireless.

The teaching device 3 is explained.

As shown in FIG. 2, the teaching device 3 has a function of designating an operation program to the robot 2. Specifically, the teaching device 3 inputs the position and the posture of the robot arm 20 to the control device 8.

As shown in FIG. 2, the teaching device 3 includes a CPU (Central Processing Unit) 31, a storing section 32, a communication section 33, and a display section 34. The teaching device 3 is not particularly limited. Examples of the teaching device 3 include a tablet computer, a personal computer, and a smartphone.

The CPU 31 reads out and executes various programs and the like stored in the storing section 32. A signal generated by the CPU 31 is transmitted to the control device of the robot 2 via the communication section 33. Consequently, the robot arm 20 can execute predetermined work under predetermined conditions.

The storing section 32 saves various programs and the like executable by the CPU 31. Examples of the storing section 32 include a volatile memory such as a RAM (Random Access Memory), a nonvolatile memory such as a ROM (Read Only Memory), and a detachable external storage device.

The communication section 33 performs transmission and reception of signals between the communication section 33 and the control device 8 using an external interface such as a wired LAN (Local Area Network) or a wireless LAN.

The display section 34 is configured by any one of various displays. In this embodiment, as an example, the display section 34 is a touch panel type, that is, the display section 34 has a display function and an input operation function.

However, the display section 34 is not limited to such a configuration and may separately include an input operation section. In this case, examples of the input operation section include a mouse and a keyboard. The touch panel, the mouse, and the keyboard may be used together.

An electric circuit of the robot 2 is explained.

As shown in FIG. 3, the robot 2 includes an AC power supply 4, which is a three-phase AC power supply, a DC conversion section 5A, AC conversion sections 5B, a detecting section 6, and power-supply adjusting sections 9 including the switches 91.

The DC conversion section 5A is an AC/DC converter. The DC conversion section 5A converts a three-phase alternating current supplied from the AC power supply 4 into a direct current. The AC conversion sections 5B are DC/AC inverters. The AC conversion sections 5B convert the direct current supplied from the DC conversion section 5A into a three-phase alternating current and output the three-phase alternating current to motors 251 to 281.

The detecting section 6 includes a first detecting section 6A and a second detecting section 6B.

The first detecting section 6A is an ammeter provided between the DC conversion section 5A and the AC conversion sections 5B. The first detecting section 6A detects a current value or a physical quantity equivalent to the current value between the DC conversion section 5A and the AC conversion sections 5B and transmits information concerning the current value or the physical quantity to the control device 8.

A detection type of the first detecting section 6A is not particularly limited. Examples of the detection type include a Hall element type including a magnetic body core and a Hall element, a current transformer type including a magnetic body core and a winding wire, a type for detecting a current value using a shunt resistor, and a combined type of these types.

The second detecting section 6B is an ammeter provided between the DC conversion section 5A and the AC conversion sections 5B. The second detecting section 6B detects a current value or a physical quantity equivalent to the current value between the DC conversion section 5A and the AC conversion sections 5B and transmits information concerning the current value or the physical quantity to the control device 8.

A detection type of the second detecting section 6B is not particularly limited. Any one of the types enumerated as the detection type of the first detecting section 6A can be used.

When the first detecting section 6A and the second detecting section 6B include the shunt resistor, a reduction in the cost of the first detecting section 6A and the second detecting section 6B can be achieved.

When the first detecting section 6A and the second detecting section 6B include the Hall element, detection accuracy of the first detecting section 6A and the second detecting section 6B can be improved.

The detection types of the first detecting section 6A and the second detecting section 6B may be the same or may be different.

In this way, the detecting section 6 is duplexed. In the robot 2, in this embodiment, only the first detecting section 6A operates at normal time and the second detecting section 6B operates when the first detecting section 6A is broken down. However, the detecting section 6 is not limited to this configuration. The detecting section 6 may have a configuration in which only the second detecting section 6B operates at normal time and the first detecting section 6A operates when the second detecting section 6B is broken down or both of the first detecting section 6A and the second detecting section 6B always operate.

Information concerning the current value or the physical quantity equivalent to the current value detected by such a detecting section 6 is transmitted to the control device 8. As explained above, the threshold of the current value is stored in the storing section 82. The CPU 81 compares a detection result of the detecting section 6 and the threshold stored in the storing section 82 and, when determining that the current value exceeds the threshold, turns off the switches 91 of the power-supply adjusting sections 9.

The power-supply adjusting sections 9 adjust power supply to the motors 251 to 281 and include the switches 91. The switches 91 are provided between motor drivers D25 to D28 and the AC conversion sections 5B. The switches 91 are configured by, for example, a semiconductor switch. The switches 91 are electrically coupled to the control device 8. The control device 8 can switch ON and OFF of energization to the motors 251 to 281 by changing a condition for energization to the switches 91.

In this way, the power-supply adjusting sections 9 include the switches 91 for switching ON and OFF of the energization to the motors 251 to 281. Consequently, ON and OFF of the energization to the motors 251 to 281 can be switched by a simple configuration in which the control device 8 changes the condition for the energization to the switches 91. Accordingly, it is possible to prevent an overcurrent from being supplied to the motors 251 to 281.

The power-supply adjusting sections 9 are not limited to the configuration explained above and may have, for example, a configuration in which the power-supply adjusting sections 9 include circuits for allowing an overcurrent to escape and switch, with the switches 91, whether to supply the overcurrent to the circuits or to supply electric power to the motors 251 to 281.

In duplexing the detecting section 6, it is conceivable to provide both of the first detecting section 6A and the second detecting section 6B on the output side of the AC conversion sections 5B, that is, between the AC conversion sections 5B and the motors 251 to 281. In this case, the first detecting section 6A and the second detecting section 6B detect a three-phase alternating current. To detect a voltage value of the three-phase alternating current, it is necessary to detect at least two of a U phase, which is a first phase, a V phase, which is a second phase, and a W phase, which is a third phase. Therefore, in this case, at least two detection elements are necessary in the first detecting section 6A. At least two detection elements are necessary in the second detecting section 6B as well. That is, in the entire detecting section 6, four detection elements are necessary.

On the other hand, in the robot 2, the first detecting section 6A and the second detecting section 6B are set between the DC conversion section 5A and the AC conversion sections 5B to detect a current value of a direct current before being input to the AC conversion sections 5B. Consequently, the first detecting section 6A can be configured to include at least one detection element that detects a current value. The second detecting section 6B can also be configured to include one detection element that detects a current value. Accordingly, in the entire detecting section 6, duplexing of the detecting section 6 can be achieved by two detection elements. As a result, it is possible to improve safety with a simple configuration.

In this way, the second detecting section 6B detects a current value of a direct current input to the AC conversion sections 5B. Consequently, it is possible to achieve duplexing of the detecting section 6 with a particularly simple configuration and improve safety.

The robot 2 may have a configuration in which, as shown in FIG. 4, the second detecting sections 6B are set between the AC conversion sections 5B and the motors 251 to 281 to detect a current value of a three-phase alternating current. In this case, the second detecting sections 6B need to detect at least two of the first phase, the second phase, and the third phase. Accordingly, at least two detection elements are necessary. In the entire detecting section 6, three detection elements are necessary. However, in this configuration, it is possible to set the number of detection elements smaller than that in the configuration in which both of the first detecting section 6A and the second detecting sections 6B detect a three-phase alternating current on the output side of the AC conversion sections 5B. Accordingly, it is possible to improve safety with a simple configuration.

In the case of this configuration, the first detecting section 6A and the second detecting sections 6B detect a current value in different parts. Therefore, when a detection abnormality occurs in one of the first detecting section 6A and the second detecting sections 6B, it is easy to specify an abnormal part.

In this way, the second detecting sections 6B detect the current value of the three-phase alternating current output by the AC conversion sections 5B. The second detecting sections 6B detect at least two of the first phase, the second phase, and the third phase. Consequently, it is possible to achieve duplexing of the detecting section 6 with a simple configuration and improve safety. It is easier to specify an abnormal part.

As explained above, the robot 2 includes the motors 251 to 281 driven by a three-phase alternating current, the AC conversion sections 5B that convert a direct current into a three-phase alternating current and output the three-phase alternating current to the motors 251 to 281, the first detecting section 6A that detects a current value of the direct current before being input to the AC conversion sections 5B, the second detecting section 6B that detects a current value of the direct current before being input to the AC conversion sections 5B or a current value of the three-phase alternating current output by the AC conversion sections 5B as shown in FIG. 4, the power-supply adjusting sections 9 that adjust power supply to the motors 251 to 281, and the control section 8A and the control section 8B that control the operation of the power-supply adjusting sections 9 based on at least one of a detection result of the first detecting section 6A and a detection result of the second detecting section 6B. Consequently, in the entire detecting section 6, duplexing of the detecting section 6 can be achieved by two or three detection elements. As a result, it is possible to improve safety with a simple configuration.

As explained above, the power-supply adjusting sections 9 shut off or reduce the power supply to the motors 251 to 281. Consequently, it is possible to further improve safety.

In this embodiment, the control device 8 is duplexed. However, the present disclosure is not limited to this. The control device 8 does not have to be duplexed.

The switches 91 may be duplexed as well.

### Second Embodiment

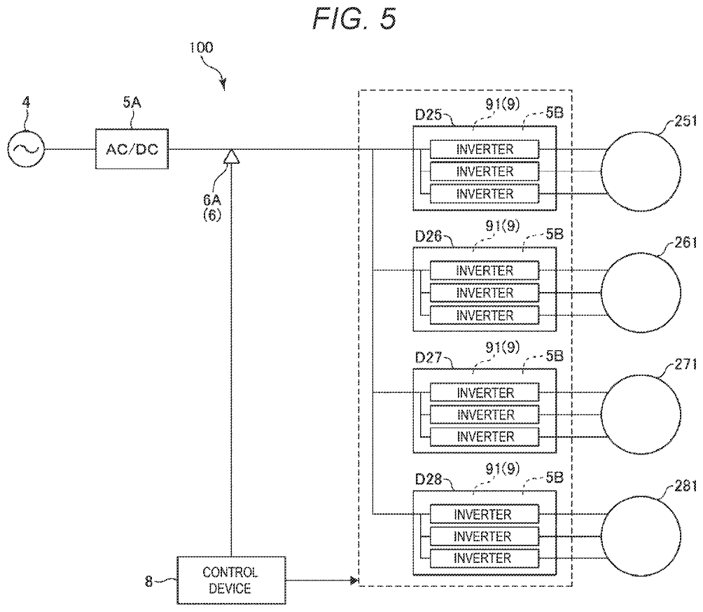

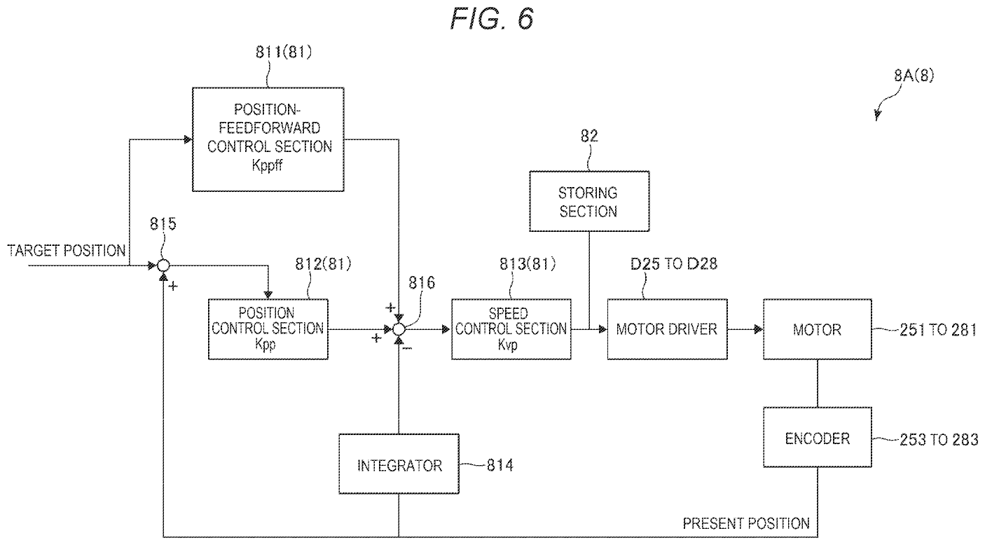

FIG. 5 is a circuit diagram of a second embodiment of the robot according to the present disclosure. FIG. 6 is a detailed circuit diagram of the robot shown in FIG. 5.

The second embodiment is explained below with reference to these figures. Differences from the first embodiment are mainly explained. Explanation about similarities to the first embodiment is omitted.

As shown in FIG. 5, the detecting section 6 includes the first detecting section 6A. The second detecting section 6B shown in FIGS. 3 and 4 is omitted.

As shown in FIG. 6, the robot 2 includes a position-feedforward control section 811, a position control section 812, a speed control section 813, an integrator 814, an adder-subtracter 815, and an adder-subtracter 816. Among these sections, the position-feedforward control section 811, the position control section 812, and the speed control section 813 are included in the CPU 81.

An input signal of a target position is input respectively to the position-feedforward control section 811 and the adder-subtracter 815. The position-feedforward control section 811 multiplies the signal of the target position by a position feedforward gain Kppff, which is a servo parameter, and outputs the signal to the adder-subtracter 816.

On the other hand, the signal of the target position input to the adder-subtracter 815 is added with a signal concerning a present position, which is a detection result of the encoders 253 to 283, by the adder-subtracter 815 and output to the position control section 812. The position control section 812 multiplies the input signal by a position control gain Kpp, which is a servo parameter, and outputs the signal to the adder-subtracter 816.

The adder-subtracter 816 adds up the signal of the target position multiplied by the position feedforward gain Kppff and the signal of the target position multiplied by the position control gain Kpp, subtracts the signal concerning the present position integrated by the integrator 814 from the added-up signal, and inputs a signal obtained by the subtraction to the speed control section 813.

The speed control section 813 multiplies the input signal by a speed control gain Kvp, which is a servo parameter, converts the signal into information concerning a current value, that is, a current command value, and outputs the current command value to the motor drivers D25 to D28. Consequently, it is possible to drive the motors 251 to 281 to move to the target position while taking into account the present position of the robot arm 20.

The current command value output by the speed control section 813 is output to the storing section 82 as well and stored in the storing section 82 at any time. In this case, the current command value is stored in a nonvolatile region of the storing section 82 and updated at any time.

The CPU 81 can determine, based on the current command value stored in the storing section 82, whether the current value is normal.

Since the control section 8A has such a configuration, even if the second detecting section 6B explained in the first embodiment is omitted, it is possible to substantially achieve duplexing of the detecting section 6. For example, even if an abnormality occurs in the first detecting section 6A, it is possible to determine, based on the current command value output by the speed control section 813, whether the current value exceeds a threshold. In this embodiment, since only one detection element of the detecting section 6 has to be provided, it is possible to further improve safety with a simpler configuration.

In this way, the robot 2 includes the motors 251 to 281 which drive by a three-phase alternating current, the AC conversion sections 5B that convert a direct current into a three-phase alternating current and output the three-phase alternating current to the motors 251 to 281, the first detecting section 6A that detects a current value of the direct current before being input to the AC conversion sections 5B, the power-supply adjusting sections 9 that adjust power supply to the motors 251 to 281, and the control section 8A and the control section 8B that control the operation of the power-supply adjusting sections 9 based on at least one of a detection result of the first detecting section 6A and a current command value to the motors 251 to 281. Consequently, in the entire detecting section 6, it is possible to substantially achieve duplexing of the detecting section 6 with one detection element. As a result, it is possible to improve safety with a simpler configuration.

The robot according to the present disclosure is explained above based on the illustrated embodiments. However, the present disclosure is not limited to the embodiments. The configurations of the sections can be replaced with any configurations having the same functions. The robot according to the present disclosure may be a robot obtained by combining the features of the embodiments. Any other components may be added to the robot according to the present disclosure.

What is claimed is:

1. A robot comprising:
a motor driven by a three-phase alternating current;
an AC conversion section configured to convert a direct current into a three-phase alternating current and output the three-phase alternating current to the motor;
a first detecting section configured to detect a current value of the direct current before being input to the AC conversion section;
a second detecting section configured to detect a current value of the direct current before being input to the AC conversion section or the three-phase alternating current output by the AC conversion section;
a power-supply adjusting section configured to adjust power supply to the motor; and
a control section configured to control operation of the power-supply adjusting section based on at least one of a detection result of the first detecting section and a detection result of the second detecting section.

2. The robot according to claim 1, wherein the power-supply adjusting section shuts off or reduces the power supply to the motor.

3. The robot according to claim 1, wherein the power-supply adjusting section includes a switch for switching ON and OFF of energization to the motor.

4. The robot according to claim 1, wherein the second detecting section detects the current value of the direct current input to the AC conversion section.

5. The robot according to claim 1, wherein
the second detecting section detects the current value of the three-phase alternating current output by the AC conversion section, and
the second detecting section detects at least two of a first phase, a second phase, and a third phase.

6. The robot according to claim 1, wherein the first detecting section and the second detecting section include a shunt resistor.

7. The robot according to claim 1, wherein the first detecting section and the second detecting section include a Hall element.

8. A robot comprising:
a motor driven by a three-phase alternating current;
an AC conversion section configured to convert a direct current into a three-phase alternating current and output the three-phase alternating current to the motor;
a first detecting section configured to detect a current value of the direct current before being input to the AC conversion section;
a power-supply adjusting section configured to adjust power supply to the motor; and
a control section configured to control operation of the power-supply adjusting section based on at least one of a detection result of the first detecting section and a current command value to the motor.
